(19) United States
(12) Patent Application Publication
(10) Pub. No.: US 2016/0156564 A1
(43) Pub. Date: Jun. 2, 2016

(54) WIRELESS COMMUNICATION METHODS

(71) Applicant: MediaTek Inc., Hsin-Chu (TW)

(72) Inventors: Yu-Ping YU, Taoyuan City (TW); Yu-Cheng CHEN, Jhubei City (TW); Ming-Fong JHANG, Zhubei City (TW)

(21) Appl. No.: 14/953,716

(22) Filed: Nov. 30, 2015

Related U.S. Application Data
(60) Provisional application No. 62/086,303, filed on Dec. 2, 2014.

(51) Int. Cl. H04L 12/807; H04L 12/815; H04W 56/00

(52) U.S. Cl. CPC H04L 47/27; H04W 56/00; H04L 47/225

(57) ABSTRACT

The wireless communication methods for avoiding HFN asynchronism between wireless communications device and network are provided. One of the wireless communication methods includes the steps of defining a receiving window; and determining whether to discard a PDU according to a sequence number (SN) of the PDU and the receiving window.

### CROSS REFERENCE TO RELATED APPLICATIONS

This Application claims priority of U.S. Provisional Patent Application No. 62/086,303, filed on Dec. 2, 2014, the entirety of which is incorporated by reference herein.

### BACKGROUND OF THE INVENTION

1. Field of the Invention

The invention generally relates to a wireless communication technology, and more particularly, to the wireless communication method for avoiding Hyper Frame Number (HFN) asynchronism between wireless communications device and network.

2. Description of the Related Art

These multiple access technologies have been adopted in various telecommunication standards to provide a common protocol that enables different wireless devices to communicate on a municipal, national, regional, and even global level. An example of an emerging telecommunication standard is Long Term Evolution (LTE). LTE is a set of enhancements to the Universal Mobile Teletransmissions System (UMTS) mobile standard promulgated by the Third Generation Partnership Project (3GPP). It is designed to better support mobile broadband Internet access by improving spectral efficiency, lowering costs, improving services, making use of new spectrums, and integrating better with other open standards using OFDMA on downlinks (DL), and SC-FDMA on uplinks (UL) and multiple-input multiple-output (MIMO) antenna technology.

FIG. 1A is a block diagram of a conventional control plane protocol stack in a wireless communications device and a LTE network. The wireless communications device includes a radio resource control (RRC) layer, a packet data convergence protocol (PDCP) layer, a radio link control (RLC) layer, a medium access control (MAC) layer and a physical (PHY) layer. The network includes a RRC layer, a PDCP layer, an RLC layer, a MAC layer and a PHY layer. The layers shown in FIG. 1A may be divided into a first layer (Layer 1), a second layer (Layer 2), and a third layer (Layer 3) based on three lower layers of a well-known interconnection scheme, such as an Open System Interconnection (OSI) reference model. FIG. 1B is a block diagram of a conventional user plane protocol stack in a wireless communications device and a LTE network. The wireless communications device includes a packet data convergence protocol (PDCP) layer, a radio link control (RLC) layer, a medium access control (MAC) layer and a physical (PHY) layer. The network includes a PDCP layer, an RLC layer, a MAC layer and a PHY layer. The layers shown in FIG. 1B may be divided into a first layer (Layer 1), a second layer (Layer 2), and a third layer (Layer 3) based on three lower layers of a well-known interconnection scheme, such as an Open System Interconnection (OSI) reference model.

In the second layer (Layer 2), a MAC layer, a radio link control (RLC) layer, and a packet data convergence protocol (PDCP) layer exist. The RLC layer handles the guaranteeing of the quality of service (QoS) of each radio bearer (RB) and the transmission of the corresponding data thereof. There are three types of RLC modes, a transparent mode (TM), an unacknowledged mode (UM), and an acknowledged mode (AM). The PDCP layer is located above the RLC layer and allows data that is transmitted by using Internet Protocol (IP) packets, such as IPv4 or IPv6, to be effectively transmitted over a radio interface having a relatively smaller bandwidth.

However, in unacknowledged mode, when an old RLC packet data unit (PDU) is outside of the reordering window, and the wireless communications device may still receive this RLC PDU due to HARQ retransmission or an unexpected event, it may result in error advance of the state variable VR(UH), and the wireless communications device may obtain a PDCP PDU for which the PDCP sequence number (SN) is old. In addition, it may result in that the PDCP Hyper Frame Number (HFN) asynchronous between wireless communications device and network. Namely, the old PDCP SN will be considered as a very new PDCP SN by the PDCP entity, and then the PDCP entity will update RX_HFN to a new value which is not expected.

### BRIEF SUMMARY OF THE INVENTION

Wireless communication methods are provided to overcome the problems mentioned above.

An embodiment of the invention provides a wireless communication method for avoiding HFN asynchronism between wireless communications device and network. The wireless communication method comprises the steps of defining a receiving window; and determining whether to discard a PDU according to a sequence number (SN) of the PDU and the receiving window.

An embodiment of the invention provides a wireless communication method for avoiding HFN asynchronism between wireless communications device and network. The wireless communication method comprises the steps of defining an expected receiving time of a sequence number (SN) of a PDCP PDU; and determining whether the receiving time of the SN of the PDCP PDU is later than or equal to an expected receiving time of the SN of the PDCP PDU.

An embodiment of the invention provides a wireless communication method for avoiding HFN asynchronism between wireless communications device and network. The wireless communication method comprises the steps of receiving a PDCP PDU; deciphering the PDCP PDU by a RX_HFN to generate data content; determining whether the data content is corrupt; and deciphering the PDCP PDU by the next RX_HFN if the data content is corrupt. The wireless communication method comprises the step of adopting the RX_HFN if the deciphered data content is not corrupt.

Other aspects and features of the invention will become apparent to those with ordinary skill in the art upon review of the following descriptions of specific embodiments of methods.

### BRIEF DESCRIPTION OF THE DRAWINGS

The invention will become more fully understood by referring to the following detailed description with reference to the accompanying drawings, wherein:

FIG. 1A is a block diagram of a conventional control plane protocol stack in a wireless communications device and a LTE network;

FIG. 1B is a block diagram of a conventional user plane protocol stack in a wireless communications device and a LTE network;

FIG. 2 is a block diagram of a mobile communications system 100 according to an embodiment of the invention;

FIG. 3 is a schematic diagram illustrating the receiving window for the UM RLC entity according to an embodiment of the invention;

FIG. 4 is a schematic diagram illustrating the receiving window for the PDCP entity according to an embodiment of the invention;

FIGS. 5A-5B are schematic diagrams illustrating for determining whether to discard an RLC PDU according to the receiving window for the UM RLC entity and the receiving window for the PDCP entity according to an embodiment of the invention;

FIG. 6 is a schematic diagram illustrating the expected receiving time for the PDCP entity according to another embodiment of the invention;

FIG. 7 is a flow chart illustrating a wireless communication method for avoiding HFN asynchronism between wireless communications device and network according to an embodiment of the invention;

FIG. 8 is a flow chart illustrating a wireless communication method for avoiding HFN asynchronism between wireless communications device and network for according to another embodiment of the invention;

FIG. 9 is a flow chart illustrating a wireless communication method for avoiding HFN asynchronism between wireless communications device and network according to another embodiment of the invention;

FIG. 10 is a flow chart illustrating a wireless communication method for avoiding HFN asynchronism between wireless communications device and network according to another embodiment of the invention.

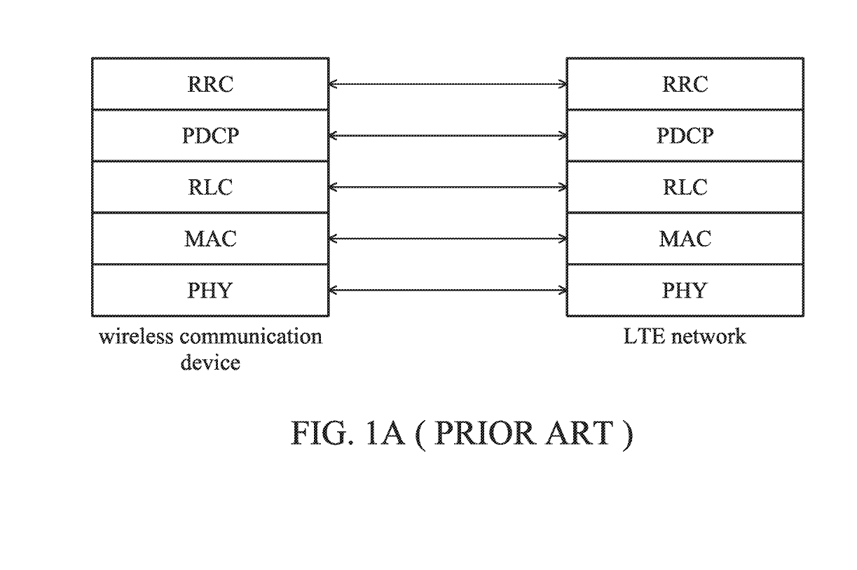

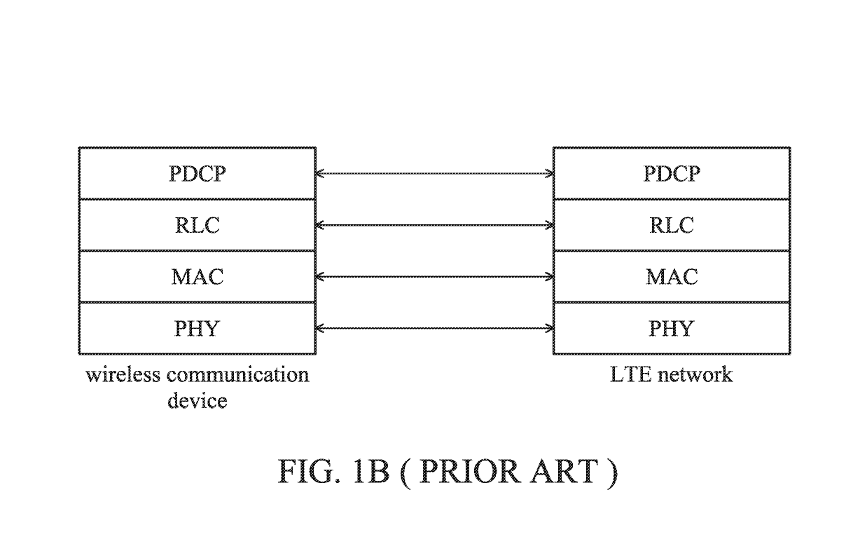

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

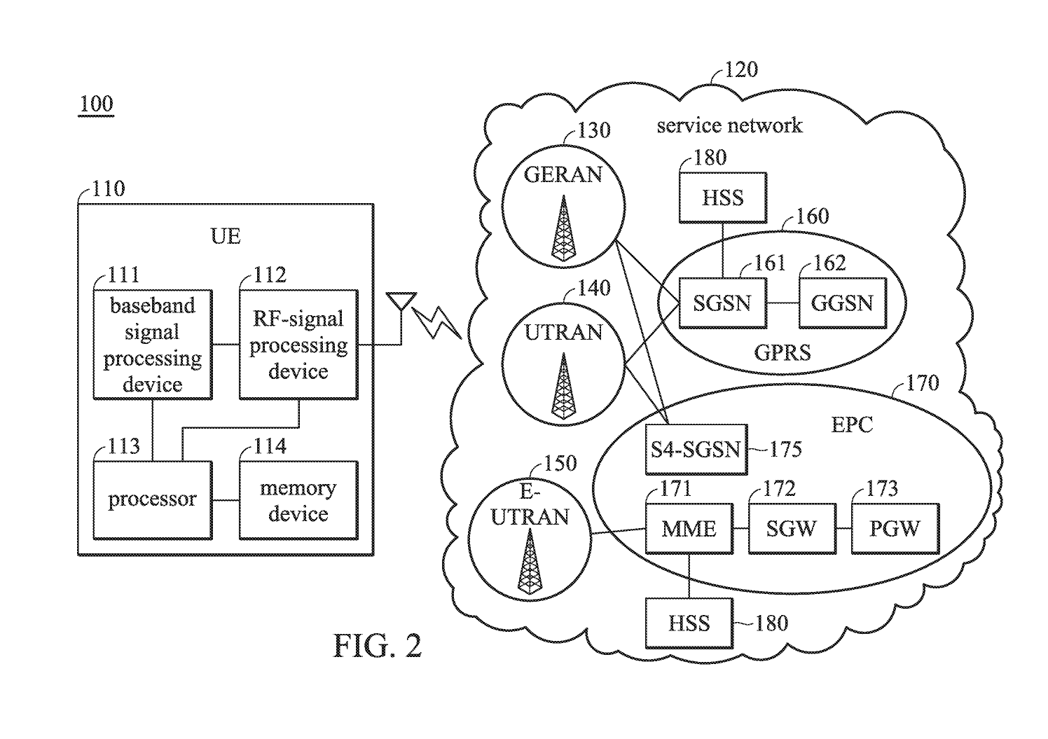

FIG. 2 is a block diagram of a mobile communications system 100 according to an embodiment of the invention. The system 100 comprises User Equipment (UE) 110 and a service network 120. The UE 110 may be a mobile communications device, such as a cellular phone, a smartphone modem processor, a data card, a laptop stick, a mobile hotspot, a USB modem, a tablet, etc.

The UE 110 may comprise at least a baseband signal processing device 111, a radio frequency (RF) signal processing device 112, a processor 113, a memory device 114, and an antenna module comprising at least one antenna. Note that, in order to clarify the concept of the invention, FIG. 2 presents a simplified block diagram in which only the elements relevant to the invention are shown. However, the invention should not be limited to what is shown in FIG. 2.

The RF signal processing device 112 may receive RF signals via the antenna and process the received RF signals to convert the received RF signals to baseband signals to be processed by the baseband signal processing device 111, or receive baseband signals from the baseband signal processing device 111 and convert the received baseband signals to RF signals to be transmitted to a peer communications apparatus. The RF signal processing device 112 may comprise a plurality of hardware elements to perform radio frequency conversion. For example, the RF signal processing device 112 may comprise a power amplifier, a mixer, etc.

The baseband signal processing device 111 may further process the baseband signals to obtain information or data transmitted by the peer communications apparatus. The baseband signal processing device 111 may also comprise a plurality of hardware elements to perform baseband signal processing. The baseband signal processing may comprise analog-to-digital conversion (ADC)/digital-to-analog conversion (DAC), gain adjustment, modulation/demodulation, encoding/decoding, and so on.

The processor 113 may control the operations of the baseband signal processing device 111 and the RF signal processing device 112. According to an embodiment of the invention, the processor 113 may also be arranged to execute the program codes of the software module(s) of the corresponding baseband signal processing device 111 and/or the RF signal processing device 112. The program codes accompanied by specific data in a data structure may also be referred to as a processor logic unit or a stack instance when being executed. Therefore, the processor 113 may be regarded as being comprised of a plurality of processor logic units, each for executing one or more specific functions or tasks of the corresponding software module(s).

The memory device 114 may store the software and firmware program codes, system data, user data, etc. of the UE 110. The memory device 114 may be a volatile memory such as a Random Access Memory (RAM); a non-volatile memory such as a flash memory or Read-Only Memory (ROM); a hard disk; or any combination thereof.

According to an embodiment of the invention, the RF signal processing device 112 and the baseband signal processing device 111 may collectively be regarded as a radio module capable of communicating with a wireless network to provide wireless communications services in compliance with a predetermined Radio Access Technology (RAT). Note that, in some embodiments of the invention, the UE 110 may be extended further to comprise more than one antenna and/or more than one radio module, and the invention should not be limited to what is shown in FIG. 2.

In addition, in some embodiments of the invention, the processor 113 may be configured inside of the baseband signal processing device 111, or the UE 110 may comprise another processor configured inside of the baseband signal processing device 111. Thus the invention should not be limited to the architecture as shown in FIG. 2.

In the embodiments of the invention, the UE 110 is configured a Radio Link Control (RLC) entity and a Packet Data Convergence Protocol (PDCP) entity.

The service network 120 may comprise a GSM EDGE Radio Access Network (GERAN) 130, a Universal Terrestrial Radio Access Network (UTRAN) 140, an Evolved UTRAN (E-UTRAN) 150, a General Packet Radio Service (GPRS) subsystem 160 and an Evolved Packet Core (EPC) subsystem 170. The GERAN 130, UTRAN 140 and E-UTRAN 150 may be in communication with the GPRS subsystem 160 or the EPC subsystem 170, wherein the GERAN 130, UTRAN 140 and E-UTRAN 150 allow connectivity between the UE 110 and the GPRS subsystem 160 or the EPC subsystem 170 by providing the functionality of wireless transmission and reception to and from the UE 110 for the GPRS subsystem 160 or the EPC subsystem 170, and the GPRS subsystem 160 or the EPC subsystem 170 signals the required operation to the GERAN 130, UTRAN 140 and E-UTRAN 150 for providing wireless services to the UE 110. The GERAN 130, UTRAN 140 and E-UTRAN 150 may contain one or more base stations (or called NodeBs or eNodeBs) and Radio Network Controllers (RNCs). Specifically, the GPRS subsystem 160 includes a Serving GPRS (General Packet Radio Services) Support Node (SGSN) 161 and a Gateway GPRS Support Node (GGSN) 162, wherein the SGSN 161 is the key control node for packet routing and transfer, mobility management (e.g., attach/detach and location management), session management, logical link management, and authentication and charging functions, etc., and the GGSN 162 is responsible for Packet Data Protocol (PDP) address assignments and inter-working with external networks. The EPC subsystem 170 may comprise a Mobility Management Entity (MME) 171, which may be responsible for idle mode UE tracking, paging procedures, and attachment and activation processes. The EPC subsystem 170 may also comprise a Servicing Gateway (SGW) 172, which may be responsible for the routing and forwarding of data packets. The EPC subsystem 170 may also include a Packet data network Gateway (PGW) 173, which may be responsible for providing connectivity from the UE 110 to external networks. Both the SGSN 161 and the MME 171 may be in communication with Home Subscriber Server (HSS) 180 which may provide device identification information, an International Mobile Subscriber Identity (IMSI), etc. It should be appreciated that the EPC subsystem 170 may also comprise a S4-SGSN 175, thereby allowing the GERAN 130 or UTRAN 140 to be accessed when the GPRS subsystem 160 is replaced by the EPC subsystem 170. Additionally, the service network 120 may further include other functional entities, such as a Home Location Register (HLR) (not shown) which is a central database storing user-related and subscription-related information, and the invention is not limited thereto. In an embodiment of the invention, the service network 120 may further comprise a Code Division Multiple Access (CDMA) network.

In an embodiment of the invention, when the Radio Link Control (RLC) entity of the UE 110 is controlled in the unacknowledged mode (UM), the processor 113 may define a reordering window and a receiving window in the RLC entity (indicate as UM RLC entity below). In an embodiment of the invention, the UM RLC entity may comprise 5 bits RLC sequence number (SN) (i.e. comprise 32 SNs) or 10 bits RLC SN (i.e. comprise 1024 SNs).

The reordering window is a value range for sequence numbers of RLC packet data units (PDUs) that the UM RLC entity receives and processes. The cover range of the reordering window is defined as [VR(UH)−reordering window size, VR(UH)), wherein [VR(UH)−reordering window size]≦VR(UR)≦VR(UH)). The state variable VR(UR) means the reception waiting number. This state variable VR(UR) refers to the very next SN after the SN of the RLC PDU that has been sequentially received most recently. The state variable VR(UH) means maximum reception number. This state variable VR(UH) refers to the upper limit value of the reordering window in the UM RLC entity and is the next value (sequence number). For example, when a RLC PDU having SN=x that falls outside the reordering window is received the VR(UH) is set as x+1.

In an embodiment of the invention, the receiving window is also a value range for sequence numbers (SN) of RLC packet data units (PDUs) in the UM RLC entity. The cover range of the receiving window is defined as [VR(UH), VR(UH)+the receiving window size). In an embodiment of the invention, the receiving window size is defined as three-fourths of the reordering window size.

In an embodiment of the invention, the processor 113 may determine whether to discard a RLC PDU according to the SN of this RLC PDU, reordering window and the receiving window. The processor 113 may determine whether the SN of this RLC PDU is in the receiving window when the SN of this RLC PDU is not in a reordering window. If the SN of this RLC PDU is not in the receiving window, the processor 113 will discard the RLC PDU. If the SN of this RLC PDU is in the receiving window, the processor 113 will receive the RLC PDU. Note that, because the reordering window has existed in conventional UM RLC entity, the invention only discusses on the situation of the SN of this RLC PDU is not in a reordering window.

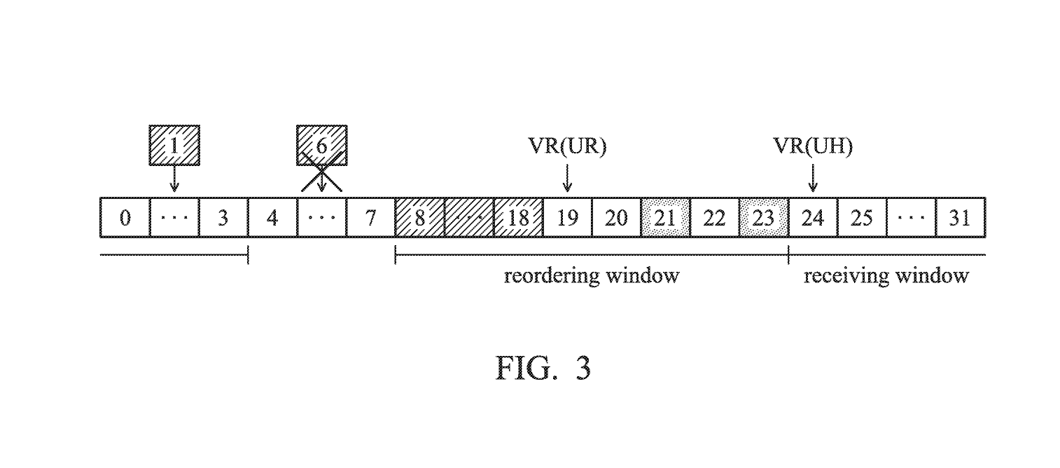

FIG. 3 is a schematic diagram illustrating the receiving window for the UM RLC entity according to an embodiment of the invention. As shown in FIG. 3, the cover range of the reordering window is from SN 8 to SN 23, and the cover range of the receiving window is from SN 24 to SN 3. When the processor 113 receives a RLC PDU with SN 6 which is not in the reordering window, the processor 113 will discard this RLC PDU because the SN 6 is also not in the receiving window. When the processor 113 receives a RLC PDU with SN 1 which is not in the reordering window, the processor 113 will receive this RLC PDU because the SN 1 is in the receiving window.

In another embodiment of the invention, for the Packet Data Convergence Protocol (PDCP) entity of the UE 110, the processor 113 may define a receiving window in the PDCP entity. In an embodiment of the invention, the PDCP entity may comprise 7 bits PDCP SN (i.e. comprise 128 SNs) or 12 bits PDCP SN (i.e. comprise 4096 SNs).

In an embodiment of the invention, the receiving window for the PDCP entity is a value range for sequence numbers (SN) of PDCP PDUs in the PDCP entity. The cover range of the receiving window is defined as [Next_PDCP_RX_SN, Next_PDCP_RX_SN+the receiving window size), where the state variable Next_PDCP_RX_SN indicates the next expected PDCP sequence number of the PDCP entity. In an embodiment of the invention, the receiving window size of the PDCP entity may be half that of the PDCP SN (i.e. comprising 64 or 2048 SNs).

In an embodiment of the invention, the processor 113 may determine whether to discard a PDCP PDU according to the SN of this PDCP PDU and the receiving window. The processor 113 may determine whether the SN of the PDCP PDU is in the receiving window. If the SN of the PDCP PDU is not in the receiving window, the processor 113 will discard the PDCP PDU. If the SN of the PDCP PDU is in the receiving window the processor 113 will receive the PDCP PDU.

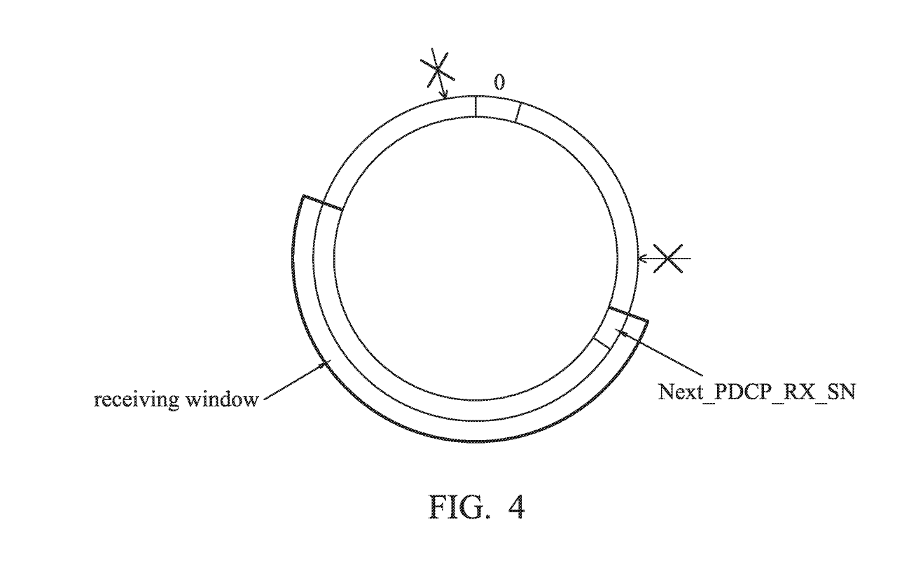

FIG. 4 is a schematic diagram illustrating the receiving window for the PDCP entity according to an embodiment of the invention. As shown in FIG. 4, when the processor 113 receives an SN of a PDCP PDU that is not in the receiving window, the processor 113 will discard the PDCP PDU. When the processor 113 receives an SN of a PDCP PDU that is in the receiving window, the processor 113 will receive the PDCP PDU.

In an embodiment of the invention, the processor 113 may determine whether the SN of the RLC PDU is in the receiving window of the UM RLC entity before determining whether the SN of the PDCP PDU is in the receiving window of the PDCP entity. That is to say, the processor 113 may determine whether the SN of the RLC PDU mapping to a PDCP PDU is in the receiving window of the UM RLC entity in the RLC layer, before determining whether the SN of the PDCP PDU is in the receiving window of the PDCP entity in the PDCP layer. If the SN of the RLC PDU mapping to a PDCP PDU is not in the receiving window of the UM RLC entity, the processor 113 will discard the RLC PDU mapping to the PDCP PDU in UM RLC entity. If the SN of the RLC PDU mapping to a PDCP PDU is in the receiving window of the UM RLC entity, the processor 113 will continue to determine whether the SN of the PDCP PDU is in the receiving window of the PDCP entity.

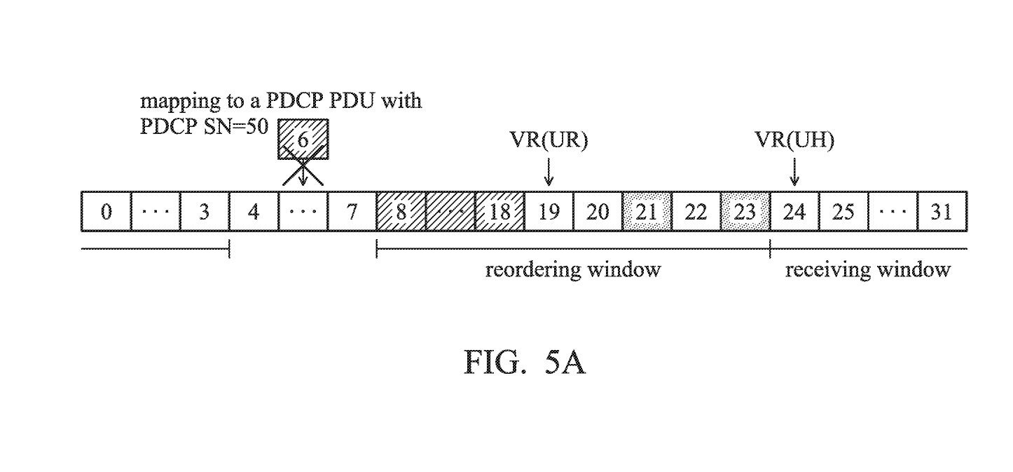

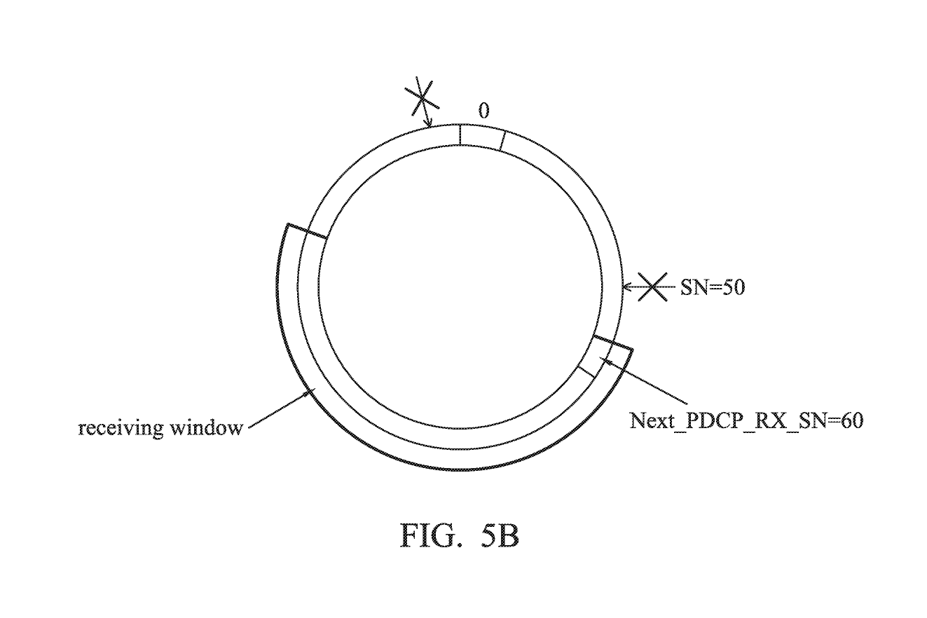

FIGS. 5A-5B are schematic diagrams illustrating for determining whether to discard an RLC PDU according to the receiving window for the UM RLC entity and the receiving window for the PDCP entity according to an embodiment of the invention. As shown in FIGS. 5A-5B, the processor 113 determines whether the SN 6 of the RLC PDU (mapping to a PDCP PDU with SN 50) is in the receiving window of the UM RLC entity before determining whether the SN 50 of the PDCP PDU is in the receiving window of the PDCP entity. Because the SN 6 is not in the receiving window and the reordering window of the UM RLC entity, the processor 113 will directly discard the RLC PDU mapping to the PDCP PDU in the UM RLC entity.

In an embodiment of the invention, the processor 113 may further determine whether the receiving time of the SN of the PDCP PDU is later than or equal to an expected receiving time corresponding to the SN of the PDCP PDU. In an embodiment of the invention, the expected receiving time corresponding to the SN of the PDCP PDU is set according the properties of the data content of the PDCP PDU. The processor 113 will take Next_PDCP_RX_SN as the reference point of the expected receiving time, and set the length of the expected receiving time according the properties of the data content of the PDCP PDU. For example, if the data content of the PDCP PDU is periodically transmitted every 10 milliseconds (ms), the processor 113 may set the expected receiving time to 10 milliseconds or more than 10 milliseconds.

When the receiving time of the SN of the PDCP PDU is later than or equal to the expected receiving time corresponding to the SN of the PDCP PDU, the processor 113 will receive the PDCP PDU. When the receiving time of the SN of the PDCP PDU is earlier than the expected receiving time corresponding to the SN of the PDCP PDU, the processor 113 discard the PDCP PDU.

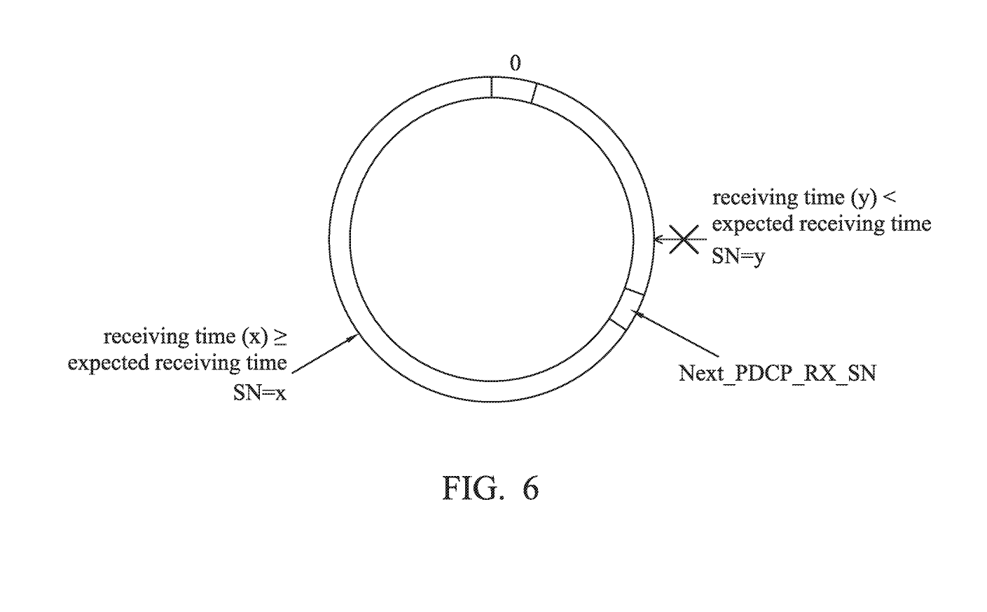

FIG. 6 is a schematic diagram illustrating the expected receiving time for the PDCP entity according to another embodiment of the invention. As shown in FIG. 6, when the receiving time (x) of the SN x of the PDCP PDU is later than or equal to the expected receiving time corresponding to the SN of the PDCP PDU, the processor 113 will receive the PDCP PDU. When the receiving time (y) of the SN y of the PDCP PDU is earlier than the expected receiving time corresponding to the SN of the PDCP PDU, the processor 113 discard the PDCP PDU.

In another embodiment of the invention, the processor 113 may only determine whether the receiving time of the SN of the PDCP PDU is later than or equal to an expected receiving time corresponding to the SN of the PDCP PDU to determine whether to discard a PDCP PDU.

In another embodiment of the invention, the processor 113 may determine whether the receiving time of the SN of the PDCP PDU is later than or equal to an expected receiving time corresponding to the SN of the PDCP PDU after determining whether the SN of the PDCP PDU is in the receiving window of the PDCP entity.

In an embodiment of the invention, the processor 113 may verify the received PDCP PDU. The processor 113 may decipher a PDCP PDU by a RX_HFN to generate data content, wherein the state variable RX_HFN indicates the hyper frame number (HFN) value for the generation of the COUNT value used for the received PDCP PDUs. Then the processor 113 may determine whether the data content of the deciphered PDCP PDU is corrupt. If the data content of the deciphered PDCP PDU is corrupt, the processor 113 will decipher the PDCP PDU by the next RX_HFN. If the data content of the deciphered PDCP PDU is not corrupt, the processor 113 will adopt the RX_HFN.

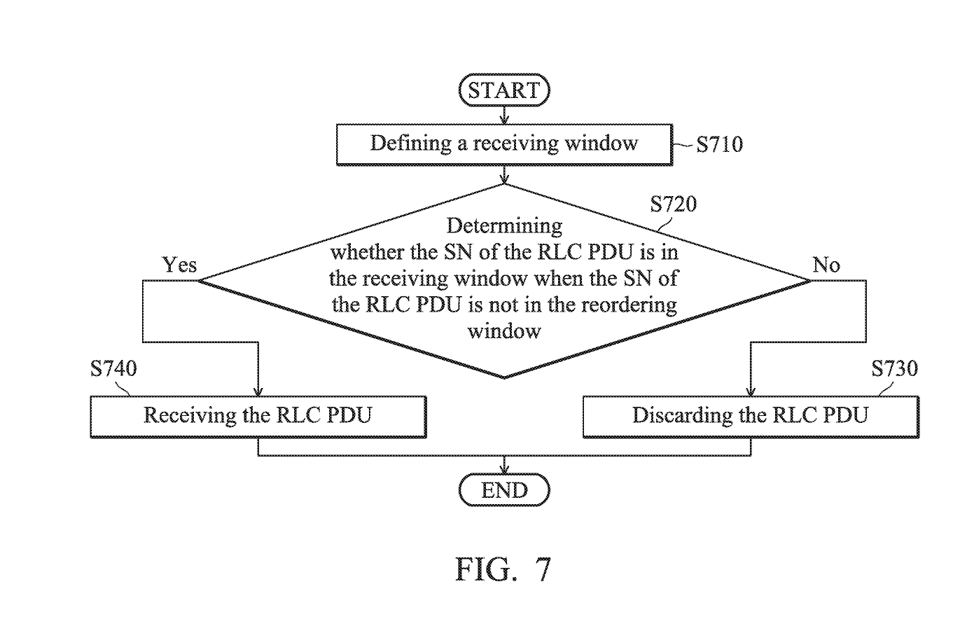

FIG. 7 is a flow chart illustrating a wireless communication method for avoiding HFN asynchronism between wireless communications device and network for according to an embodiment of the invention. The wireless communication method is applied to the UE 110. In the embodiment of the invention, the receiving window corresponds to the UM RLC entity and the PDU is a RLC PDU. First, in step S710, the UE 110 defines a receiving window. In step S720, the UE 110 determines whether the SN of the RLC PDU is in the receiving window when the SN of the RLC PDU is not in the reordering window. When the SN of the RLC PDU is not in the receiving window, step S730 will be performed. In step S730, the UE 110 will discard the RLC PDU. When the SN of the RLC PDU is in the receiving window, step S740 will be performed. In step S740, the UE 110 will receive the RLC PDU. In the embodiment of invention, the receiving window has a receiving window size, and a cover range of the receiving window is defined as [VR(UH), VR(UH)+the receiving window size).

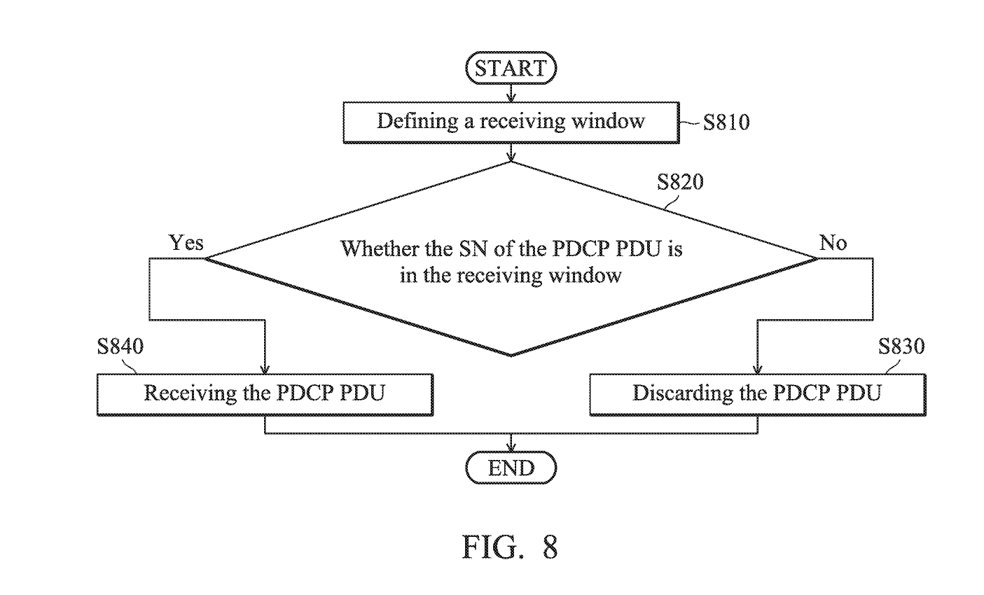

FIG. 8 is a flow chart illustrating a wireless communication method for avoiding HFN asynchronism between wireless communications device and network for according to another embodiment of the invention. The wireless communication method is applied to the UE 110. In the embodiment of the invention, the receiving window corresponds to the PDCP entity and the PDU is a PDCP PDU. First, in step S810, the UE 110 defines a receiving window. In step S820 comprises the UE 110 determines whether the SN of the PDCP PDU is in the receiving window. When the SN of the PDCP PDU is not in the receiving window, step S830 will be performed. In step S830, the UE 110 will discard the PDCP PDU. When the SN of the PDCP PDU is in the receiving window, step S840 will be performed. In step S840, the UE 110 will receive the PDCP PDU. In the embodiment of invention, the receiving window has a receiving window size, and a cover range of the receiving window is defined as [Next_PDCP_RX_SN, Next_PDCP_RX_SN+the receiving window size).

In the above embodiment of the invention, in step S820, the UE 110 may determine whether the SN of the RLC PDU mapping to a PDCP PDU is in a receiving window (regarded as second receiving window) of the UM RLC entity before determining whether the SN of the PDCP PDU is in the receiving window. When the SN of the RLC PDU mapping to a PDCP PDU is in the second receiving window of the UM RLC entity, the UE 110 will sequentially determine whether the SN of the PDCP PDU is in the receiving window. When the SN of the RLC PDU is not in the second receiving window of the UM RLC entity, the UE 110 will discard the RLC PDU mapping to the PDCP PDU.

In an embodiment of the invention, the UE 110 may determine whether the receiving time of the SN of the PDCP PDU is later than or equal to an expected receiving time corresponding to the SN of the PDCP PDU. When the receiving time of the SN of the PDCP PDU is later than or equal to the expected receiving time corresponding to the SN of the PDCP PDU, the UE 110 will receive the PDCP PDU. When the receiving time of the SN of the PDCP PDU is earlier than the expected receiving time corresponding to the SN of the PDCP PDU the UE 110 will discard the PDCP PDU.

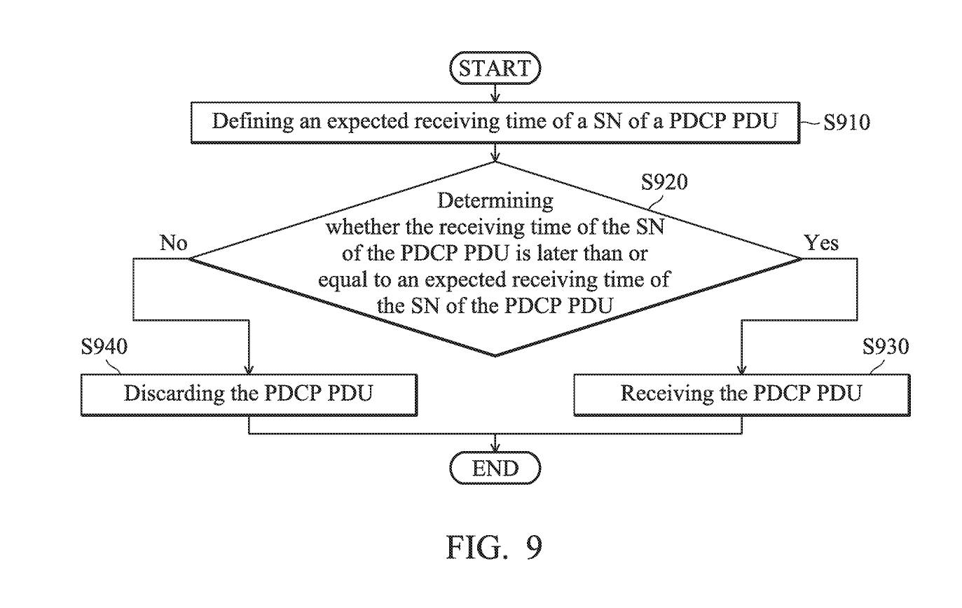

FIG. 9 is a flow chart illustrating a wireless communication method for avoiding HFN asynchronism between wireless communications device and network according to another embodiment of the invention. The wireless communication method is applied to the UE 110. First, in step S910, the UE 110 defines an expected receiving time of a sequence number (SN) of a PDCP PDU. In step S920, the UE 110 determines whether the receiving time of the SN of the PDCP PDU is later than or equal to an expected receiving time of the SN of the PDCP PDU. When the receiving time of the SN of the PDCP PDU is later than or equal to the expected receiving time of the SN of the PDCP PDU, step S930 is performed. In step S930, the UE 110 will receive the PDCP PDU. When the receiving time of the SN of the PDCP PDU is earlier than the expected receiving time of the SN of the PDCP PDU, step S940 is performed. In step S940, the UE 110 will discard the PDCP PDU.

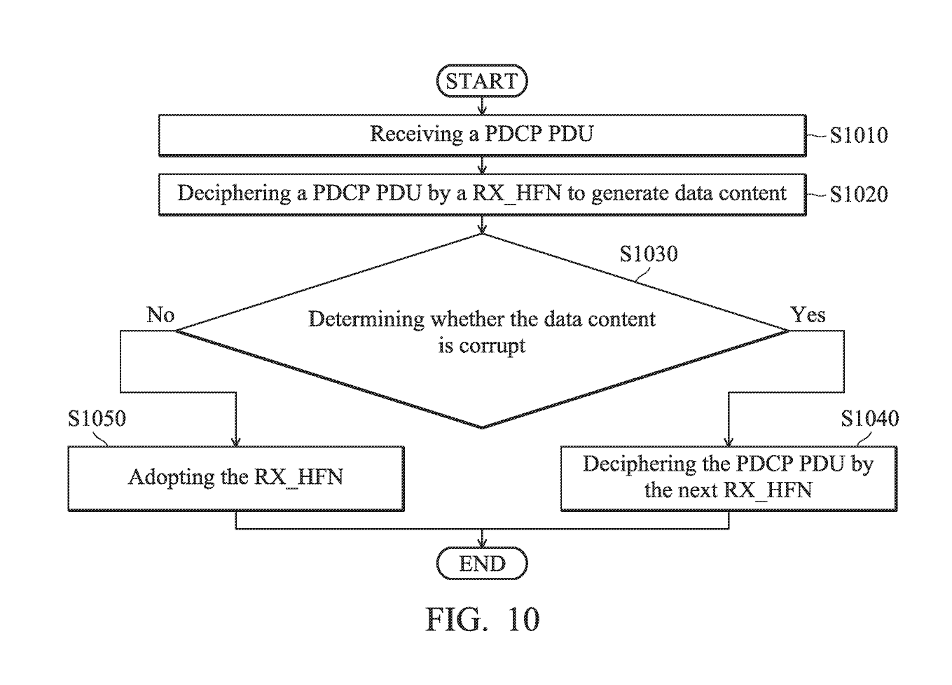

FIG. 10 is a flow chart illustrating a wireless communication method for avoiding HFN asynchronism between wireless communications device and network according to another embodiment of the invention. The wireless communication method is applied to the UE 110. First, in step S1010, the UE 110 receives a PDCP PDU. In step S1020, the UE 110 deciphers the PDCP PDU by a RX_HFN to generate data content. In step S1030, the UE 110 determines whether the data content is corrupt. If the data content is corrupt, step S1040 will be performed. In step S1040, the UE 110 will decipher the PDCP PDU by the next RX_HFN. If the data content is corrupt, step S1050 will be performed. In step S1050, the UE 110 will adopt the RX_HFN.

In the wireless communication method for avoiding HFN asynchronism between wireless communications device and network of the invention, the UE 110 can avoid HFN asynchronism between wireless communications device and network by setting the receiving window or expected receiving time. In addition, the UE 110 can verify whether the data content of the deciphered PDCP PDU is corrupt, and modify the corrupt data content by different RX_HFN.

The steps of the method described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such that the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer software product may comprise packaging materials.

It should be noted that although not explicitly specified, one or more steps of the methods described herein can include a step for storing, displaying, and/or outputting, as required for a particular application. In other words, any data, records, fields, and/or intermediate results discussed in the methods can be stored, displayed, and/or output to another device as required for a particular application. While the foregoing is directed to embodiments of the present invention, other and further embodiments of the invention can be devised without departing from the basic scope thereof. Various embodiments presented herein, or portions thereof, can be combined to create further embodiments. The above description is of the best-contemplated mode of carrying out the invention. This description is made for the purpose of illustrating the general principles of the invention and should not be taken in a limiting sense. The scope of the invention is best determined by reference to the appended claims.

The above paragraphs describe many aspects. Obviously, the teaching of the invention can be accomplished by many methods, and any specific configurations or functions in the disclosed embodiments only present a representative condition. Those who are skilled in this technology can understand that all of the disclosed aspects in the invention can be applied independently or be incorporated.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A wireless communication method for avoiding HFN asynchronism between wireless communications device and network, comprising:
defining a receiving window; and
determining whether to discard a PDU according to a sequence number (SN) of the PDU and the receiving window.

2. The wireless communication method of claim 1, wherein if the receiving window corresponds to the UM RLC entity and the PDU is a RLC PDU, the wireless communication method further comprises:
determining whether the SN of the RLC PDU is in the receiving window when the SN of the RLC PDU is not in a reordering window.

3. The wireless communication method of claim 2, further comprising:
discarding the RLC PDU when the SN of the RLC PDU is not in the receiving window; and
receiving the RLC PDU when the SN of the RLC PDU is in the receiving window.

4. The wireless communication method of claim 2, wherein the receiving window has a receiving window size, and a cover range of the receiving window is defined as [VR(UH), VR(UH)+the receiving window size).

5. The wireless communication method of claim 1, wherein if the receiving window corresponds to a PDCP entity and the PDU is a PDCP PDU, the wireless communication method further comprises:
determining whether the SN of the PDCP PDU is in the receiving window.

6. The wireless communication method of claim 5, further comprising:
discarding the PDCP PDU when the SN of the PDCP PDU is not in the receiving window; and
receiving the PDCP PDU when the SN of the PDCP PDU is in the receiving window.

7. The wireless communication method of claim 5, wherein the receiving window has a receiving window size, and a cover range of the receiving window is defined as [Next_PDCP_RX_SN, Next_PDCP_RX_SN+the receiving window size).

8. The wireless communication method of claim 5, further comprising:
determining the SN of a RLC PDU mapping to the PDCP PDU is in a second receiving window of a UM RLC entity before determining whether the SN of the PDCP PDU is in the receiving window of the PDCP entity.

9. The wireless communication method of claim 8, further comprising:
determining whether the SN of the PDCP PDU is in the receiving window of the PDCP entity when the SN of the RLC PDU mapping to the PDCP PDU is in the second receiving window of the UM RLC entity; and
discarding the RLC PDU mapping to the PDCP PDU when the SN of the RLC PDU is not in the second receiving window of the UM RLC entity.

10. The wireless communication method of claim 5, further comprising:
determining whether a receiving time of the SN of the PDCP PDU is later than or equal to an expected receiving time corresponding to the SN of the PDCP PDU when the SN of the PDCP PDU is not in the receiving window.

11. The wireless communication method of claim 10, further comprising:
receiving the PDCP PDU when the receiving time of the SN of the PDCP PDU is later than or equal to the expected receiving time corresponding to the SN of the PDCP PDU; and
discarding the PDCP PDU when the receiving time of the SN of the PDCP PDU is earlier than the expected receiving time corresponding to the SN of the PDCP PDU.

12. A wireless communication method for avoiding HFN asynchronism between wireless communications device and network, comprising:
defining an expected receiving time of a sequence number (SN) of a PDCP PDU;
and determining whether a receiving time of the SN of the PDCP PDU is later than or equal to an expected receiving time of the SN of the PDCP PDU.

13. The wireless communication method of claim 12, further comprising:
receiving the PDCP PDU when the receiving time of the SN of the PDCP PDU is later than or equal to the expected receiving time of the SN of the PDCP PDU; and
discarding the PDCP PDU when the receiving time of the SN of the PDCP PDU is earlier than the expected receiving time of the SN of the PDCP PDU.

14. The wireless communication method of claim 12, further comprising:
determining whether the receiving time of the SN of the PDCP PDU is later than or equal to the expected receiving time corresponding to the SN of the PDCP PDU when the SN of the PDCP PDU is not in a receiving window.

15. A wireless communication method for avoiding HFN asynchronism between wireless communications device and network, comprising:
receiving a PDCP PDU;
deciphering the PDCP PDU by a RX_HFN to generate data content;
determining whether the data content is corrupt; and
deciphering the PDCP PDU by a next RX_HFN if the data content is corrupt.

16. The wireless communication method of claim 15, further comprising:
adopting the RX_HFN if the deciphered data content is not corrupt.
